(19) United States
(12) Patent Application Publication
(10) Pub. No.: US 2024/0136840 A1
(43) Pub. Date: Apr. 25, 2024

(54) CHARGE-DISCHARGE CONTROL DEVICE

(71) Applicant: TOYOTA JIDOSHA KABUSHIKI KAISHA, Toyota-shi (JP)

(72) Inventors: Toshinori OKURA, Toyota-shi (JP); Kiwamu KOBAYASHI, Anjo-shi (JP)

(73) Assignee: TOYOTA JIDOSHA KABUSHIKI KAISHA, Toyota-shi (JP)

(21) Appl. No.: 18/366,110

(22) Filed: Aug. 6, 2023

(30) Foreign Application Priority Data
Oct. 23, 2022 (JP) 2022-170069

(51) Int. Cl. H02J 7/00

(52) U.S. Cl. CPC H02J 7/00712; H02J 2207/20

(57) ABSTRACT

The charge-discharge control device includes an alternating current-direct current converter that converts AC power from a primary side into DC power, a direct current bus that distributes power from the alternating current-direct current converter, a plurality of channels connected in parallel to the direct current bus, and a processor configured to control a current of charging or discharging of a secondary battery connected to the channel so as to minimize power supplied from the primary side.

### CROSS-REFERENCE TO RELATED APPLICATION

This application claims priority to Japanese Patent Application No. 2022-170069 filed on Oct. 24, 2022, incorporated herein by reference in its entirety.

### BACKGROUND

### 1. Technical Field

The present disclosure relates to a charge-discharge control device.

### 2. Description of Related Art

Japanese Unexamined Patent Application Publication No. 2013-160652 (JP 2013-160652 A) discloses a technique for suppressing power consumption by performing timing control such that peak power is reduced in a charge-discharge inspection of a secondary battery.

### SUMMARY

However, when the timing control is performed, a secondary battery waiting for the start of an inspection comes into existence, and thus there is an issue that production decreases.

The present disclosure has been made in view of the above, and an object of the present disclosure is to provide a charge-discharge control device capable of minimizing required electric power while maintaining the production.

A charge-discharge control device according to the present disclosure includes: an alternating current-direct current converter that converts alternating current power from a primary side into direct current power; a direct current bus that distributes electric power from the alternating current-direct current converter; a plurality of channels, the channels being connected in parallel with each other to the direct current bus; and a processor configured to control a charge or discharge current value for a secondary battery connected to each of the channels such that electric power supplied from the primary side is minimized.

According to the present disclosure, it is possible to realize a charge-discharge control device capable of minimizing required electric power while maintaining the production.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a charging and discharging system including a charge-discharge control device according to an embodiment;

FIG. 2 is a flowchart illustrating a process executed by the charge-discharge control device according to the embodiment;

FIG. 3 is a diagram showing a situation in which a secondary power supply is not connected to one channel; and

FIG. 4 is a diagram illustrating a state in which a secondary power supply is connected to an open channel.

### DETAILED DESCRIPTION OF EMBODIMENTS

A charge-discharge control device according to an embodiment of the present disclosure will be described with reference to the drawings. Incidentally, the constituent elements in the following embodiments include those that can be easily replaced by a person skilled in the art or those that are substantially the same.

### Embodiments

### Schematic Configuration of Charging and Discharging System

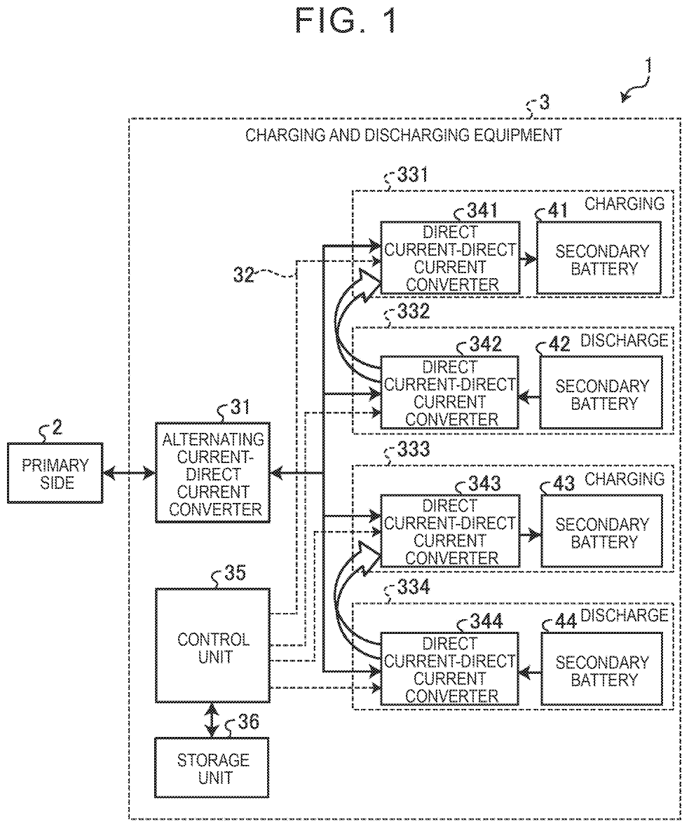

FIG. 1 is a schematic configuration diagram of a charge/discharge system including a charge-discharge control device according to an embodiment. The charging/discharging system 1 illustrated in FIG. 1 is a charging/discharging system that supplies AC power from the primary side 2 to the charge-discharge control device 3 and performs an inspection of the operation confirmation of charging/discharging of the secondary batteries 41 to 44 connected to the charge-discharge control device 3.

The primary side 2 is, for example, a three-phase alternating current of 400 V. The voltage or the like of the primary side 2 is not particularly limited.

The charge-discharge control device 3 controls electric power to be charged and discharged from the secondary battery 41 to the secondary battery 44.

The secondary batteries 41 to 44 may be any type of secondary battery as long as the secondary battery can be charged and discharged.

### Configuration of Charge-Discharge Control Device

The charge-discharge control device 3 includes an alternating current (AC)-direct current (DC) converter 31, a direct current bus 32, channels 331 to 334, a control unit 35, and a storage unit 36.

The alternating current-direct current converter 31 converts AC power from the primary side 2 into DC power.

The direct current bus 32 distributes the power from alternating current-direct current converters 31 from the channels 331 to 334. The direct current bus 32 is also used for power interchange between the channels 331 to 334.

The channels 331 to 334 are connected in parallel to the direct current busses 32. The channels 331 to 334 each have direct current-direct current converters 341 to 344.

The direct current-direct current converters 341 to 344 convert the DC power. The direct current-direct current converters 341 to 344 can be charged and discharged independently under the control of the control unit 35.

The control unit 35 is configured by using a memory and a processor including hardware such as a CPU. The control unit 35 reads the program recorded in the storage unit 36 into a work area of the memory and executes the program. The control unit 35 controls each component and the like through execution of a program by the processor. As a result, the control unit 35 realizes a functional module in which hardware and software cooperate to meet a predetermined purpose.

The control unit 35 controls direct current-direct current converters 341 to 344. Thus, the control unit 35 controls the current value of charging or discharging of the secondary batteries 41 to 44 connected to the channels 331 to 334 so as to minimize the power supplied from the primary side 2. In addition, when the secondary batteries 41 to 44 are connected to or disconnected from the channels 331 to 334, the control unit 35 may control the current value of charging or discharging of the secondary batteries 41 to 44 connected to the channels 331 to 334 so as to minimize the power supplied from the primary side 2. In addition, the control unit 35 may control the current value of charging or discharging to the secondary batteries 41 to 44 connected to the channels 331 to 334 so as to have the current value within the process specification range of the channels 331 to 334.

The storage unit 36 stores various programs executed by the control unit 35.

### Operation of Charge-Discharge Control Device

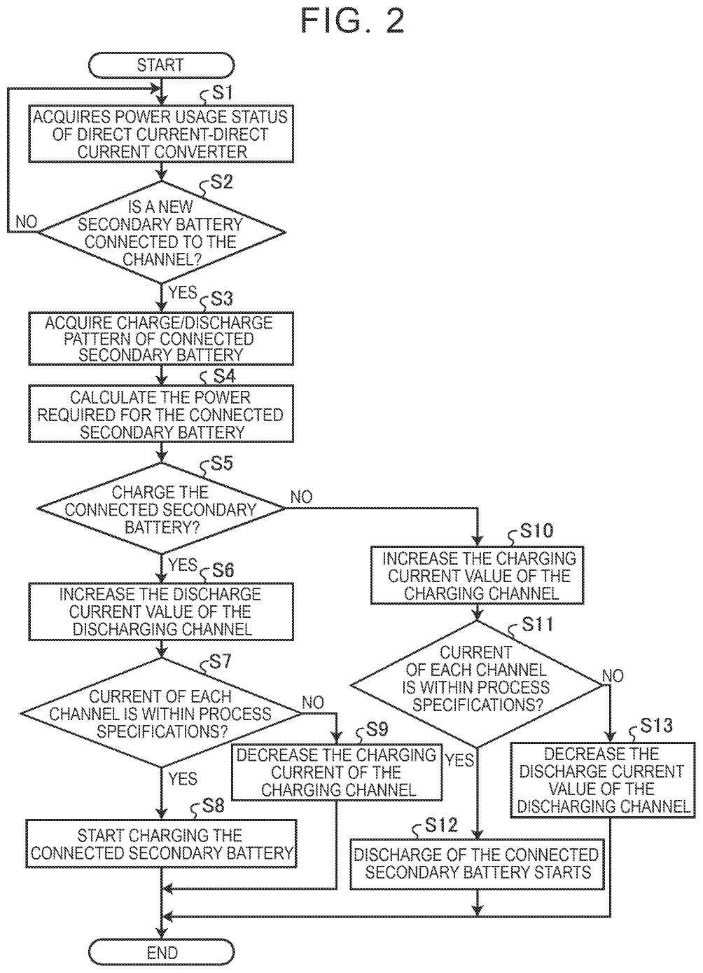

FIG. 2 is a flowchart illustrating a process executed by the charge-discharge control device according to the embodiment. As illustrated in FIG. 2, the control unit 35 acquires the power usage status of direct current-direct current converters 341 to 344 (S1).

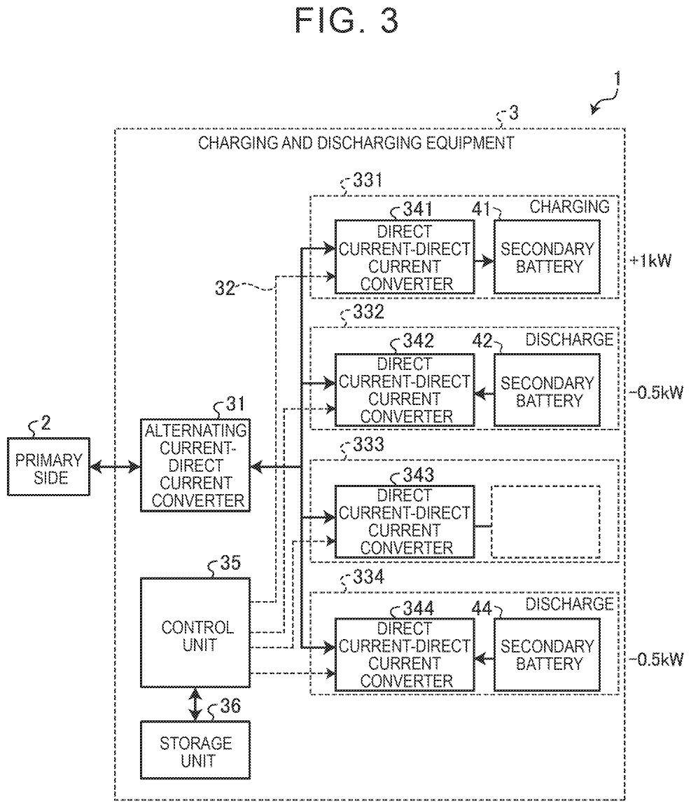

FIG. 3 is a diagram illustrating a state in which a secondary power supply is not connected to one channel. As shown in FIG. 3, a secondary battery is not connected to the channel 333. Therefore, the control unit 35 determines that the secondary battery is not connected to the channel 333 from the acquired power usage status. In this condition, the sum of the charge current value (+1.0 kW) and the sum of the discharge current values (−1.0 kW) are balanced, and the power supplied from the primary side 2 is minimized (±0 kW).

Subsequently, the control unit 35 determines whether a new secondary battery is connected to the channels 331 to 334 (S2). When the control unit 35 determines that the new secondary battery is not connected to the channels 331 to 334 (S2: No), the process returns to S1 and repeats the process.

On the other hand, when the control unit 35 determines that the new secondary battery is connected to the channels 331 to 334 (S2: Yes), the control unit 35 acquires the charge/discharge pattern of the connected secondary battery (S3).

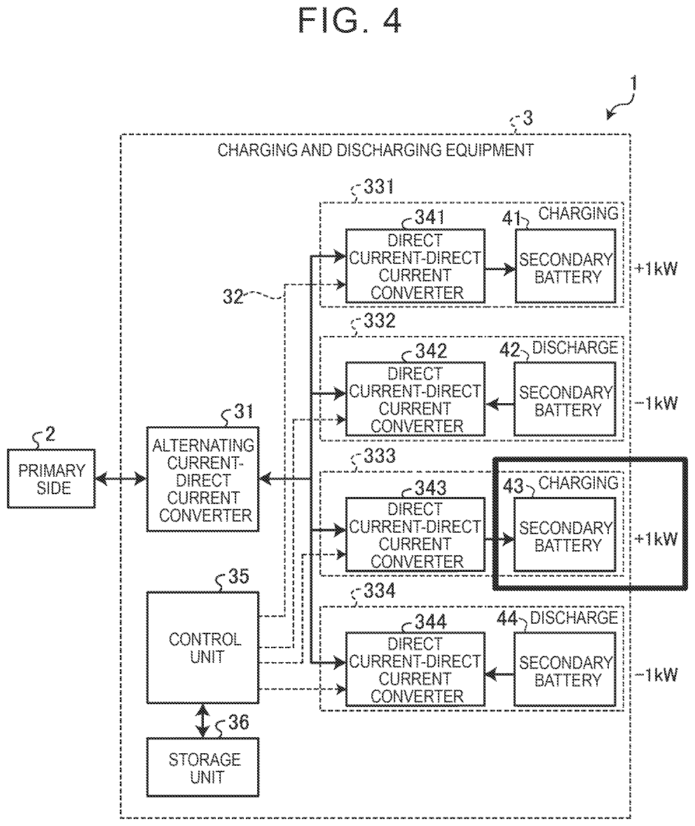

FIG. 4 is a diagram illustrating a state in which a secondary power supply is connected to an open channel. As illustrated in FIG. 4, when the secondary battery 43 is connected to the channel 333, the control unit 35 determines that a new secondary battery is connected to the channels 331 to 334. Then, the control unit 35 acquires the charge/discharge pattern of the connected secondary battery 43.

Then, the control unit 35 calculates electric power required for the connected secondary battery 43 (S4).

Further, the control unit 35 determines whether or not the connected secondary battery 43 is a secondary battery that needs to be charged based on the calculated electric power (S5).

When the control unit 35 determines that the secondary battery 43 is a secondary battery that needs to be charged (S5: Yes), the control unit 35 increases the discharge current of the discharging channels 332 and 334 (S6). Specifically, the control unit 35 increases the discharging current of the channels 332 and 334 from −0.5 kW shown in FIG. 2 to −1.0 kW shown in FIG. 3. Consequently, the sum of the charge current value (+2.0 kW) and the sum of the discharge current values (−2.0 kW) are balanced, and the power supplied from the primary side 2 can be minimized (±0 kW).

Thereafter, the control unit 35 determines whether or not the currents of the channels 331 to 334 are within the process specification (S7). The process specification range of the current is defined in each of the secondary batteries 41 to 44. When the current exceeds the process specification range, the secondary batteries 41 to 44 may deteriorate. Therefore, the current should be set to a current value within the process specification range.

When the control unit 35 determines that the currents of the channels 331 to 334 are within the process standard (S7: Yes), the control unit 35 starts charging the connected secondary battery 43 (S8). Note that the control unit 35 exchanges electric power between the channels 331 to 334 via direct current busses 32. When excess or deficiency of electric power occurs, the control unit 35 may supply electric power from the primary side 2 via the alternating current-direct current converter 31 or regenerate electric power to the primary side 2.

On the other hand, when the control unit 35 determines that the currents of the channels 331 to 334 are not within the process standard (S7: No), the control unit 35 lowers the charge current of the channels 331 and 333 that are being charged (S9). At this time, the control unit 35 may uniformly reduce the current values of the channels 331 and 333. In addition, the control unit 35 may selectively lower the current value of the channel in which the current exceeds the process standard. The control unit 35 may increase the current value of the channel in which the current has a margin with respect to the process standard. Thereafter, the process proceeds to S8, and the control unit 35 starts to charge the connected secondary battery 43.

In S5, when the control unit 35 determines that the secondary battery 43 is not a secondary battery that needs to be charged, that is, the secondary battery 43 is a secondary battery that needs to be discharged (S5: No), the control unit 35 increases the charge current of the channels that are being charged (S10).

Thereafter, the control unit 35 determines whether or not the currents of the channels 331 to 334 are within the process specification (S11).

When the control unit 35 determines that the currents of the channels 331 to 334 are within the process standard (S11: Yes), the control unit 35 starts discharging the connected secondary battery 43 (S12).

On the other hand, when the control unit 35 determines that the currents of the channels 331 to 334 are not within the process standard (S11: No), the control unit 35 lowers the discharge current of the discharging channel (S13). Thereafter, the process proceeds to S8, and the control unit 35 starts to charge the connected secondary battery 43.

According to the charge-discharge control device 3 described above, the control unit 35 controls the current value of charge or discharge to the secondary batteries 41 to 44 connected to the channels 331 to 334 so as to minimize the power supplied from the primary side 2. Therefore, the required power can be minimized while maintaining the number of production.

Note that, in the flowchart of FIG. 2, the case where the secondary batteries 41 to 44 are connected to the channels 331 to 334 has been described, but by performing the same processing even when the connection of the secondary batteries 41 to 44 from the channels 331 to 334 is released, the required power can be minimized while maintaining the number of production. Specifically, when the connection of the secondary batteries 41 to 44 from the channels 331 to 334 is released, the control unit 35 may control the current value of charging or discharging of the secondary batteries 41 to 44 connected to the channels 331 to 334 so as to minimize the power supplied from the primary side 2.

Further advantages and variations can be readily derived by those skill in the art. Thus, the broader aspects of the disclosure are not limited to the specific details and representative embodiments presented and described above. Accordingly, various modifications may be made without departing from the spirit or scope of the general inventive concept as defined by the appended claims and their equivalents.

What is claimed is:

1. A charge-discharge control device comprising:
an alternating current-direct current converter that converts alternating current power from a primary side into direct current power;
a direct current bus that distributes electric power from the alternating current-direct current converter;
a plurality of channels, the channels being connected in parallel with each other to the direct current bus; and
a processor configured to control a charge or discharge current value for a secondary battery connected to each of the channels such that electric power supplied from the primary side is minimized.

2. The charge-discharge control device according to claim 1, wherein the channels each include a direct current-direct current converter that changes a voltage of the direct current power.

3. The charge-discharge control device according to claim 1, wherein when the secondary battery is connected to or disconnected from each of the channels, the processor controls the charge or discharge current value for the secondary battery connected to each of the channels such that the electric power supplied from the primary side is minimized.

4. The charge-discharge control device according to claim 1, wherein the processor controls the charge or discharge current value for the secondary battery connected to each of the channels to be a current value within a process standard range of each of the channels.
